(19) United States
(12) Patent Application Publication
(10) Pub. No.: US 2017/0200133 A1
(43) Pub. Date: Jul. 13, 2017

(54) CONTEXTUAL TASK MANAGEMENT SYSTEM

(71) Applicant: SAP SE, Walldorf (DE)

(72) Inventors: Sebastian WERNER, Mannheim (DE); Philip Leonard Miseldine, Karlsruhe (DE); Judith Sarai Hoetzer, Sulzfeld (DE); Klaus Herter, Leimen (DE); Gisbert Robert Georg Loff, Hockenheim (DE)

(21) Appl. No.: 15/392,419

(22) Filed: Dec. 28, 2016

Related U.S. Application Data
(60) Provisional application No. 62/278,170, filed on Jan. 13, 2016.

(51) Int. Cl. G06Q 10/10; G06Q 10/06

(52) U.S. Cl. CPC G06Q 10/1097; G06Q 10/0633

(57) ABSTRACT

The present disclosure provides methods, devices, systems, and computer program products for dynamic task management utilizing contextual information and biosensor data to rank workflow items in order of importance. The dynamic task management system may use biosensor data to predict a user's emotional state, correlate the predicted emotion with specific contextual information, and use these combinations of data to rank and prioritize workflow items. The dynamic task management system continuously evaluates the combination of contextual information and biosensor data to generate a dynamic priority list displaying to the user the most important workflow items. The dynamic task management system may also present contextual artifacts to the user related to a respective workflow item.

### CROSS-REFERENCE TO RELATED APPLICATIONS

The present application claims priority to U.S. Provisional Patent Application No. 62/278,170 filed Jan. 13, 2016, entitled “Contextual Task Management System,” which is herein incorporated by reference in its entirety.

### BACKGROUND

In the current business environment, users are inundated with an ever-increasing amount of demands on their attention. In addition to typical workplace obligations such as meetings or deadlines, things such as email, chat, alerts, or other notifications from applications are constantly competing for a user's attention. Although individual applications may be designed with the user's perspective in mind, a collection of applications taken together can become overwhelming when each is continuously pinging the user with information, notices and alarms of varying importance.

Daily execution of a user's tasks becomes difficult as they become inundated with more and more information as a result of this influx, making it difficult to keep track of the workload that must be accomplished and the appropriate applications to use to complete their work. Furthermore, devoting the proper amount of attention to the task at hand becomes impossible with so many distractions competing for the user's attention.

Some of these communications, notifications, information aril alerts may actually be useful to the user's present task, but with no way to prioritize them or relate them to the current user context, there is a risk that both important and unimportant information may be treated the same or ignored. As a result, important, helpful, or necessary information may be lost in the noise.

Often, and increasingly, there are simply too many distractions for a user to work efficiently. These problems will only continue to grow as more and more physical and virtual objects are embedded with electronics, software, sensors, and network connectivity to collect and exchange data. The amount of data to be interpreted and analyzed is growing exponentially, as is the number of applications that manipulate and interpret that data.

### BRIEF DESCRIPTION OF THE DRAWINGS

The accompanying drawings are incorporated herein and form a part of the specification.

FIG. 1 is a diagram illustrating an example of a dynamic task management system, according to some embodiments.

FIG. 2 is a flowchart illustrating a process for dynamic task management, according to some embodiments.

FIG. 3 is a flowchart illustrating a process for the prioritization of workflow items, according to some embodiments.

FIG. 4 is a block diagram illustrating a log file, according to some embodiments.

FIG. 5 is a flowchart illustrating a process for creating a log file, according to some embodiments.

FIG. 6 is diagram illustrating an example graphical user interface (GUI) for a task management system, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for dynamic task management utilizing contextual information and/or biosensor data.

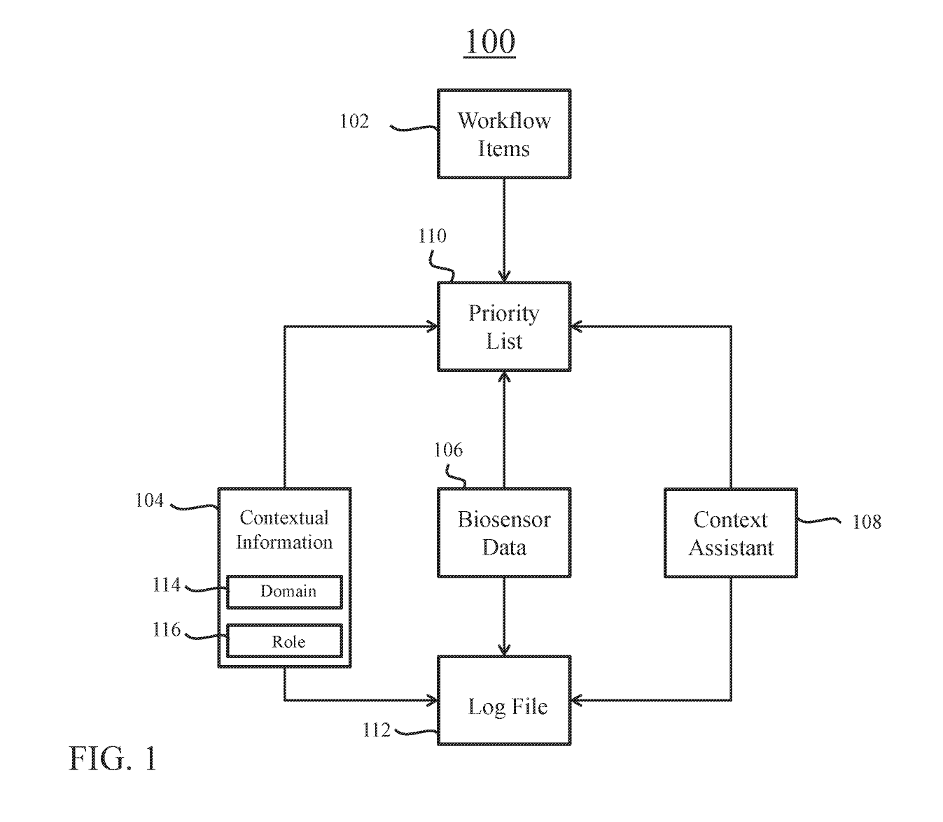

FIG. 1 is a block diagram illustrating the components of a dynamic task management system 100, according to some embodiments.

In an embodiment, task management system 100 may prioritize and rank multiple workflow items 102 in parallel. Workflow items 102 may include the tasks, goals, interruptions, or any combination thereof, related to a user's professional position. For example, workflow items 102 may include the tasks, goals, interruptions, or any combination thereof—related to a user's job, profession, assigned tasks, or any combination thereof—to name a few examples. According to an embodiment, a task may include a workflow item 102 that is necessary for a user to fulfill its professional position. A task may include, for example, purchasing parts, meetings to attend, individuals to contact, deadlines, project progression, work travel, or any combination thereof—to name a few examples. According to an embodiment, tasks may defer depending on the professional position of the user—i.e. users with different positions and professional responsibilities may have different tasks presented.

According to an embodiment, a goal may include an aspirational workflow item 102 for a user according to inputs received by task management system 100. For example, task management system 100 may receive inputs encompassing data indicating a user's desire to leave work by 6:30 PM on a particular evening, discuss a promotion, complete 50% of a report by the end of the week, or any combination thereof—to name a few examples. According to an embodiment, a goal may further include the progress towards an aspirational workflow item 102. For example, a goal may include the total accomplishment, current progress towards accomplishment, the average pace towards achievement—or any combination thereof—of aspirational workflow items 102 set according to the inputs received by task management system 100.

In an embodiment, interruptions may encompass workflow items 102 that break a user's workflow, demand attention, reduce productivity, or any combination thereof. For example, an interruption may include emails, chats, phone calls, unexpected tasks, or any combination thereof—to name a few examples. As non-limiting examples, an interruption may include breaks from workflow when a user's colleague becomes ill, completing an ill colleague's tasks, or receiving a phone call from a family member—to name a few examples.

According to an embodiment, task management system 100 may accomplish the prioritization and ranking of workflow items 102 by leveraging contextual information 104 and/or biosensor information 106 to determine the relative importance of various workflow items i.e. task management system 100 may prioritize and rank workflow items 102 according to contextual information 104 and biosensor information 106. According to an embodiment, once work flow items 102 are prioritized and ranked, priority list 110 may display the prioritized and ranked workflow items 102. Priority list 110 may comprise a user interface object that may display information related to or representing prioritized and ranked work flow items 102. In an embodiment, task management system 100 may indicate the priority of workflow items 102 by ordering them by rank, color coding the priority, sizing the workflow items by priority, or any combination thereof, to name just a few examples. According to an embodiment, the priority may include ranking workflow items 102 by deadline, importance, user stress level, ability, time, achieving a goal, or any combination thereof, to name just a few examples.

In an embodiment, contextual information 104 may include any data to which the task management system 100 may be given access. According to an embodiment, contextual information 104 may be used to generate new workflow items 102, prioritize existing workflow items 102, rank existing workflow items 102, or any combination thereof to name a few examples. According to an embodiment, contextual information 104 may be taken (i.e., pulled, pushed, received, or any combination thereof) from a variety of sources. These sources may include, for example, a user's calendar and e-mail (e.g., an e-mail exchange server), chat or instant messaging programs, SMS/MMS systems, the telephone, other messaging facilities, social media platforms, internal enterprise systems, external enterprise systems, or any combination thereof—to name a few examples. In an embodiment, contextual data 104 retrieved from the sources may be obtained through any typical means, such as, for example, APIs, interfaces, protocols, or any combination thereof.

According to an embodiment, contextual information 104 may relate to a user's professional domain 114 and/or role 116. A domain 114 may comprise a broad categorization of a user's position. For example, a domain 114 may comprise the department, branch, office—or any combination thereof—of a user. A role 116 may comprise narrower categorization of a user's position. For example, a role 116 may comprise a user's group, project, team—or any combination—within the user's domain 114. According to an embodiment, contextual information 104 related to a user's domain 114 or role 116 may include, for instance, the tasks of users within a domain 114 or role 116 most often completed, the standard workflow information of users within a domain 114 or role 116, the deadline most often associated with user in within a domain 114 or role 116, or any combination thereof—to name a few examples.

In an embodiment, contextual information 104 may include information derived from one or more sensors that report on the environmental conditions of a user's physical environment. These environmental conditions may include, for example, ambient light, weather, temperature, humidity, office location, geographical location, or any combination thereof.

According to an embodiment, contextual information 104 may comprise information and information sources, relating to other user(s) associated with a user—i.e., contextual information 104 may comprise, for example, a user's colleagues' calendars, e-mails, instant messaging or any combination thereof—as it relates to the user's workflow items 102. As a non-limiting example, contextual information 104 related to a user's colleagues may indicate that a particular workflow item 102 impacts, for example, three of the user's colleagues, while a different workflow item 102 impacts, for example, five of the user's colleagues. Information related to a user's colleagues may also include, for example, the manner in which colleagues accomplish certain tasks, how long they typically take to accomplish those tasks, or any combination thereof.

In other embodiments, contextual information 104 may be received by task management system 100 as interactions—such as, for example, interactions from a keyboard, mouse, touchpad, touchscreen, microphone, or any combination thereof. Contextual information 104 received as interactions may be direct, i.e., generated specifically for the purpose of being entered into the task management system 100, or indirect, i.e., generated in another context, for example while working on a workflow item 102 (but may nonetheless be useful to task management system 100).

According to an embodiment, task management system 100 may semantically understand the content of contextual information 104 data sources. In other embodiments, the information threads from various independent contextual information 104 data sources may be analyzed and joined to determine contextual information 104 across different sources. As a non-limiting example, an upcoming meeting may be discussed via a phone call, an e-mail, and an instant messaging chat. Task management system 100 may join these separate information threads together to form a more complete understanding of the user's workflow items 102.

In an embodiment, task management system 100 may receive a user's privacy settings. A user's privacy settings may include data limiting the type, scope, nature—or any combination thereof—of contextual information 104 that is available to task management system 100. For example, a user's privacy setting may comprise data allowing task management system 100 to access, for example, the user's calendar and email system as sources for contextual information 104, but deny access to, for example, the user's telephone or SMS/MMS system. In an embodiment, the user's privacy settings may also limit the manner in which contextual information 104 is utilized by task management system 100. For example, the user's privacy settings may comprise data allowing certain contextual information 104 to be used by task management system 100 to generate and prioritize that user's workflow items 102, but may also comprise data denying the use of that contextual information 104 by task management system 100 as it relates to another user's workflow items 102.

According to an embodiment, task management system 100 may receive biosensor data 106 that can be used to prioritize and rank workflow items 102. For example, biosensor data 106 may be used by task management system 100 to determine a user's emotional state—such as, for example, if a user is calm or stressed. In an embodiment, biosensor data 106 may be provided to task management system 100 through one or more sensors such as heart rate monitors, blood pressure sensors, skin conductivity sensors, or any combination thereof—to name a few examples. According to an embodiment, biosensor data 106 may also be provided by, for example, one or more cameras, which may allow task management system 100 to, for example, interpret facial expressions or measure pupil dilation. It is to be understood by those of skill in the art that the described examples are not to be limiting, but that a user's physical reaction to various emotions may be measured by any existing or to be developed component, machine, means and/or process, as understood in the art within the scope of the present disclosure.

According to an embodiment, biosensor data 106 may be tracked across workflow items 102. For example, biosensor data 106 may be collected while a user is working on a workflow item 102. As a non-limiting example, biosensor data 106 may be collected while a user is performing a speech (i.e., a workflow item 102). Biosensor data 106 collected during progression of a workflow item 102 may be stored and associate with the workflow item 102 during which it was collected.

In an embodiment, a goal may comprise a desired biosensor data 106 value. For example, a goal may be to reduce stress, heartbeat, blood pressure—or any combination thereof—of the user while a workflow item 102 is being performed.

In an embodiment, task management system may evaluate workflow items 102, contextual information 104, and/or biosensor data 106 to generate and display priority list 110. Priority list 110 may include the main view of the task management system 100 (such as, for example, within a user interface), and may represent a list of ranked and prioritized work flow items 102 for a user—i.e., what workflow items 102 the user may wish to focus on in the order of importance, where the order is based on contextual information 104 and/or biosensor data 106, to name a few examples. In an embodiment, the highest prioritized workflow item 102 may be placed at the top of the list, with other workflow items 102 appearing below in decreasing order of importance. In other embodiments, a workflow item 102's importance may be indicated through other visual means, such as color (e.g., a red item is critically important, and a yellow item must be addressed in the immediate future), size (e.g., more important items appear larger), transparency (e.g., less important items have increased transparency), brightness (e.g., less important items have reduced brightness), shape, animation, or any combination thereof—to name a few examples.

According to an embodiment, priority list 110 may be dynamic, and the ordering of workflow items 102 within priority list 110 may be continuously adjusted as task management system 100 incorporates and analyzes additional workflow items 102, contextual data 104, and biosensor data 106. In generating priority list 110, task management system 100 may utilize any number of different mechanisms, such as, for example, algorithms, logic, rules—or any combination thereof—in evaluating workflow items 102, contextual data 104, and biosensor data 106 in order to prioritize and rank workflow items 102. In an embodiment, task management system 100 may employ any number of different auto-learning capabilities such that the manner in which it utilizes workflow items 102, contextual data 104, and biosensor data 106 is modified over time as the system learns the user and the user's workflow.

In an embodiment, task management system 100 may comprise context assistant 108, which provides and displays contextual artifacts to a user for each of the ranked workflow items 102 displayed on the priority list 110. According to an embodiment, context assistant 108 may provide and display to the user context-based artifacts related to a particular workflow item 102. These artifacts may include, for example, files, documents, email conversations, chat messages, voicemails, or any combination thereof. In an embodiment, context assistant 108 is capable of semantically understanding the content of an artifact, and may highlight important keywords or display them as tags. In another embodiment, the context assistant 108 may be able to support a user with intelligent suggestions for how to accomplish a particular workflow item 102. This may include displaying, for example, standard workflows, the manner in which the majority of other users accomplished the task at hand, steps to guide a user through an unknown business process, or any combination thereof. According to an embodiment, the context assistant 108 may support the user by automating certain tasks. This may be accomplished as task management system 100 learns the user's behavior, routines, and typical ways of handling workflow items.

In an embodiment, task management system 100 may generate log file 112. Task management system 100 may collect and record the information utilized during the ranking and prioritization process of workflow items 102 in log file 112 for later review and analysis by the user. According to an embodiment, log file 112 may keep track of a user's emotions (as determined by biosensor data 106) as it relates to specific contextual information 104. Task management system 100 may use this combination of contextual information 104 and emotional response in the biosensor data 106 to generate a consequential action for related workflow items 102.

In an embodiment, task management system 100 may be a standalone application, or may be integrated into another application or user environment. The user environment may comprise aspects of an enterprise software system, applying modern design principles for a completely reimagined user experience that among other things delivers a personalized, responsive, seamless, and simple user experience across applications (including legacy and new), devices (including, inter cilia, desktop computer, notebook computer, laptop computer, tablet, smartphone, smartwatch, etc.), and deployment options (such as for example on-premise, cloud, as-a-service, etc.).

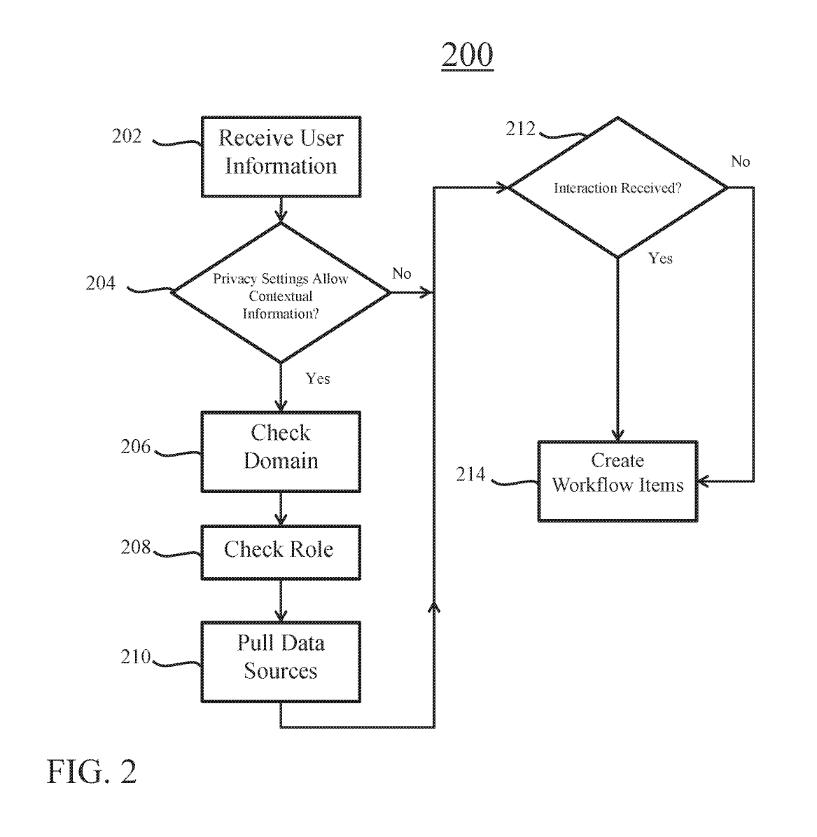

FIG. 2 is a flowchart illustrating a method 200 for workflow item creation, according to an embodiment. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1. However, method 200 is not limited to that example embodiment.

At 202, task management system 100 may receive user information. User information may include user identification information, login information, privacy settings, or any combination thereof—to name a few examples. In an embodiment, user information may be received as interactions, such as, for example, interactions from a keyboard, mouse, touchpad, touchscreen, microphone, or any combination thereof.

At 204, task management system 100 may determine whether the user's privacy settings allow for contextual information to be used in the creation of workflow items 102. If task management system 100 determines that the user's privacy settings allow for the use of contextual information then the system may move to 206, otherwise the system may move to 212.

At 206, task management system 100 may determine the domain 114 of the user. As discussed with respect to FIG. 1, the domain 114 of a user may include the user's department, branch, office, or any combination thereof, to name a few examples. According to an embodiment, task management system 100 may search for workflow items 102 related to the user's domain 114. For example, task management system 100 may search for meetings, tasks, deadlines, projects or any combination thereof—related with the user's domain 114.

At 208, task management system 100 may determine the role 116 of the user. As discussed with respect to FIG. 1, the role 116 of a user may include the user's group, project, team, or any combination thereof, to name a few examples. According to an embodiment, task management system 100 may search for workflow items 102 related to the user's role 116. For example, task management system 100 may search for meetings, tasks, deadlines, projects—or any combination thereof—related with the user's role 116.

At 210, task management system 100 may access and retrieve contextual information 104 from a variety of sources related to the user. As discussed with respect to FIG. 1, task management system 100 may access (i.e., pull, push received, or any combination thereof) contextual information 104 from a variety of sources related to the user such as, for example, a user's calendar, e-mail, chat, instant messaging programs, SMS/MMS systems, telephone, other messaging facilities, social media platforms, internal enterprise systems, external enterprise systems, or any combination thereof. Using this contextual information, task management system 100 may determine workflow items 102. For example, from the contextual information 104, task management system 100 may determine appointments, contacts, calls, projects, deadlines—or any combination thereof for the user.

At 212, task management system 100 may determine if any workflow items 102 have been received as interactions. As discussed with respect to FIG. 1, task management system 100 may receive workflow items as interactions, such as interactions from a keyboard, mouse, touchpad, touchscreen, microphone, or any combination thereof). If no workflow item have been received as interactions, then the task management system 100 may move to 216, otherwise the task management system 100 may move to 214. Further, according to an embodiment, in step 212 task management system 100 may determine which workflow items 102 have been received as interactions. For example, task management system 100 may receive a user's contacts, appointments, meetings, projects, deadlines, goals—or any combination thereof—as interactions.

At 214, task management system 100 may create workflow items 102 for the user. According to an embodiment, the created workflow items 102 for the user may comprise the workflow items 102 identified at step 206, 208, 210 and/or 214, or any combination thereof. In an embodiment, and as further described below, the created workflow items for the user may be prioritized, ranked, and displayed in priority list 110.

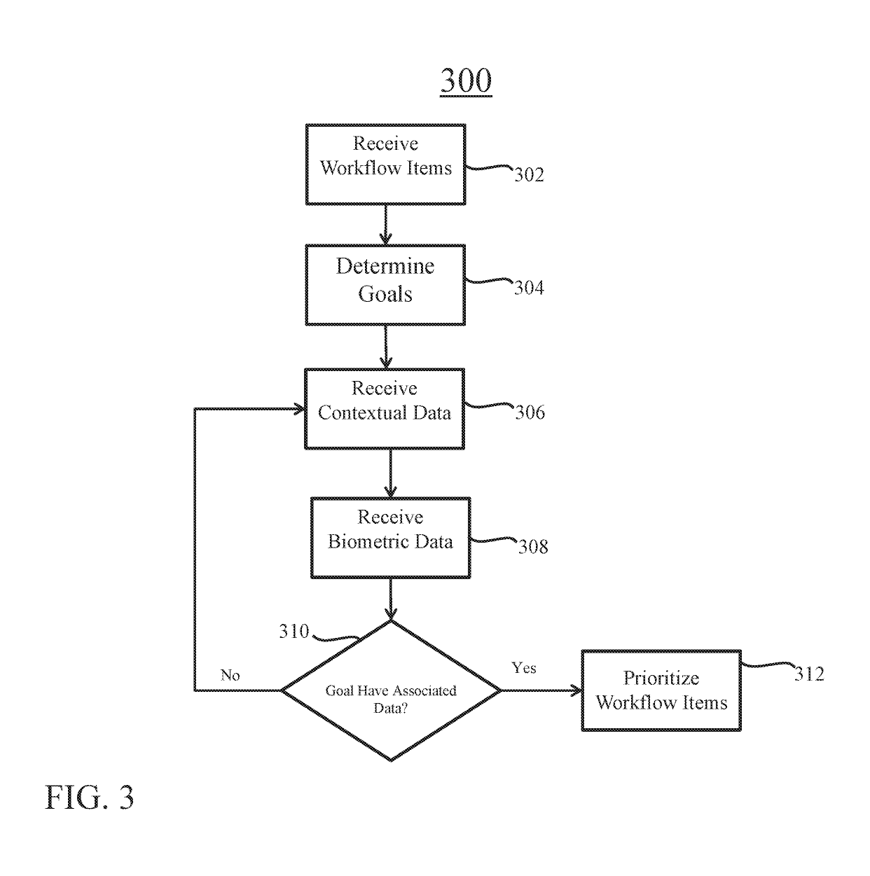

FIG. 3 is a flowchart illustrating a method 300 for the prioritization of workflow items, according to an embodiment. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1. However, method 300 is not limited to that example embodiment.

At 302, task management system 100 may access workflow items 102 that were created for a user, as discussed in FIG. 2. As discussed in FIG. 1, workflow items 102 may include tasks, goals, and interruptions.

At 304, task management system 100 may determine which of the user's workflow items 102 are associated with the user's current goals. For example, the user's current goals may include goals of completing 50% of a project by a certain date, keeping stress to a minimum, finishing assigned tasks by 6:30 PM, etc. In step 304, task management system 100 may determine which of the user's workflow items 102 are associated with these current goals of the user.

At 306, task management system 100 may access contextual data 104 related to a user's workflow items 102. According to an embodiment, the contextual data may include a user's calendar and email chat or instant messaging programs, SMS/MMS systems, the telephone, other messaging facilities, social media platforms, internal enterprise systems, external enterprise systems, information related to a user's domain 114, information related to a user's role 116, a user's environmental conditions, a user's colleagues' contextual information, or any combination thereof. For example, task management system 100 may access a user's calendar for the day, the user's tasks for the day, calls to be made, or any combination thereof to name a few examples.

At 308, task management system 100 may access biosensor data for the user, taken under varying conditions of the user. In an embodiment, biosensor data may comprise data from one or more biosensors taken when a user has completed past workflow items, is working on current workflow items, at random intervals, or any combination thereof to name a few examples. These biosensors may include, for example, heart rate monitors, blood pressure sensors, skin conductivity sensors, or any combination thereof.

At 310, task management system 100 may determine whether any of the user's current goals are associated with any of the contextual data received at 306—i.e. if any of the received contextual data is related to any of the user's current goals. For example, the user may have a current goal to finish a task by 50% by the end of the day, and the task management system 100 may have received contextual data indicating the rate at which the user's colleagues' finish the same or similar tasks. In this example, the task management system 100 may determine that the user's goal (i.e., finish a given task by 50% by the end of the day) is related to the received contextual data (i.e., the rate at which co-workers finish the same or similar goals). In this case, the system moves to 312, otherwise 306 is repeated.

At 312, task management system 100 may prioritize and rank the user's workflow items 102. According to an embodiment, task management system 100 may prioritize, rank and/or schedule the user's workflow items 102 associated with the user's goals identified at 304, so as to accomplish such goals. This may include prioritizing workflow items 102 that need to be completed first, prioritizing stressful workflow items for less stressful times, prioritizing tasks to lessen stress, or any combination thereof—to name a few examples. Step 312 is performed using the user's contextual data 104 obtained in step 306 and the user's biometric data 106 obtained in step 308.

As a non-limiting example of step 312, assume that at step 304 the user's workflow items 102 associated with the following 2 goals were identified: (1) reduce stress, and (2) complete a task by 50% by the end of the day. At steps 306 and 308, task management system 100 may receive contextual data 104 and/or biosensor data 106 indicating (a) the user historically needs 3 hours to get a task done by 50%, (b) the user's colleagues are least stressed working on this type of task from the hours of 10:00 AM to 2:00 PM, and (c) the user historically takes an hour for a lunch break. To accomplish the two identified goals given such contextual data 104 and/or biosensor data 106, task management system 100 may generate the priority list 110 such that the user's workflow items 102 associated with the 2 goals are scheduled to be performed by the user from 10:00 AM to 2:00 PM. This would enable the user to finish the task by 50% by the end of the day, while taking a normal lunch break and reducing stress.

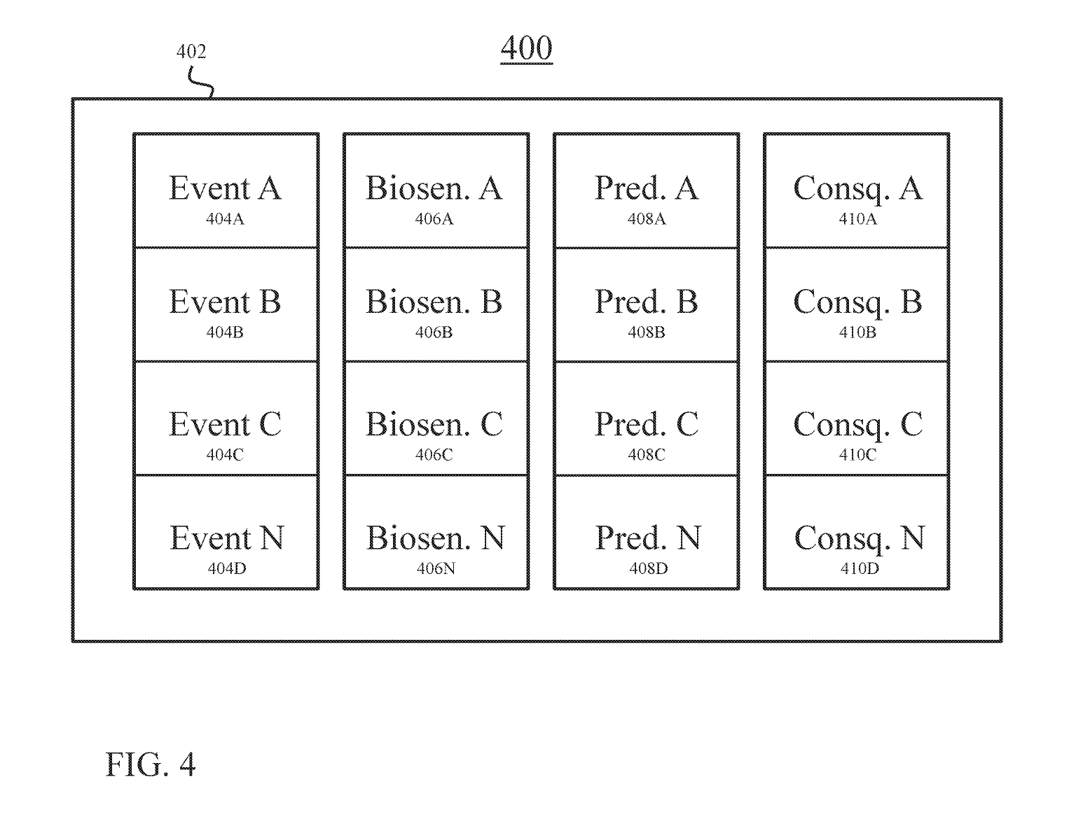

FIG. 4 is a block diagram illustrating a log file 402, according to an embodiment.

As discussed with reference to FIG. 1, a log file 402 may be created by task management system 100 by recording and logging received workflow items 102, contextual data 104, biosensor data 106, and/or contextual artifacts. In an embodiment, log file 402 may store information relating to a workflow item 102 and the contextual data 104, biosensor data 106, and contextual artifacts associated with the workflow item 102. In an embodiment, log file 402 may store the associated contextual data 104, biosensor data 106, and contextual artifacts for a workflow item 102 over any period of time. In an embodiment, the task management system 100 may display any portion of the log 402 to the user.

For example, a workflow item 102 may relate to a speech to be made by a user. For this workflow item, the contextual data 104, biosensor data 106, and contextual artifacts associated with the speech may be stored in the log file 402, such as heart rate during the speech, a text document of the speech, critiques of the speech, or any combination thereof.

According to an embodiment, log file 402 may store a plurality of workflow items 102 and contextual data 104, biosensor data 106, and contextual artifacts associated with the workflow items 102.

In an embodiment, log file 402 may store similar workflow items 102 over a period of time (for example, days, weeks, months, years, or any combination thereof). For example, log file 402 may store the speeches that a user has given over the course of a year. Log file 402 may further store the contextual data 104, biosensor data 106, and contextual artifacts associated with the workflow items 102, such as heart rate during the speeches, a text document of the speeches, critiques of the speeches, or any combination thereof.

According to another embodiment, log file 402 may store a workflow item 102 and associated contextual data 104, biosensor data 106, and contextual artifacts for a plurality of users. For example, log file 402 may store the workflow item 102 including a training and the associated contextual data 104, biosensor data 106, and contextual artifacts associated with the workflow items 102 for the training for any number of user's.

Log files 402 shall now be described in greater detail. According to an embodiment, log file 402 may comprise a user interface object including one or more events 404 (such as, for example, event A 404A, event B 404B, event C 404C, event N 404D, or any combination thereof), one or more biosensor data 406 (such as, for example, biosensor data A 406A, biosensor data B 406B, biosensor data C 406C, biosensor data N 406D, or any combination thereof), one or more predictions 408 (such as, for example, prediction A 408A, prediction B 408B, prediction C 408C, prediction N 408D, or any combination thereof), and one or more consequences 410 (such as, for example, consequence A 410A, consequence B 410B, consequence C 410C, consequence N 410D, or any combination thereof).

According to an embodiment, events 404 may comprise a workflow item 102 (task, goal, interruption, or any combination thereof) that has occurred. Events 404 may include events that have occurred over any period of time, such as one or more hours, days, weeks, months, years,—or any combination thereof. In an embodiment, events 404 may include any number of events, such as, for example, from 1 to N events.

In an embodiment, each event 404 may be associated with or related to a respective biosensor data 406. For example, event A 404A may be related to biosensor data A 406A, event B 404B may be related to biosensor data B 406B, event C 404C may be related to biosensor data C 406C, and event N 404D may be related to biosensor data N 406D. According to an embodiment, biosensor data 406 may include data received from biosensors 130 during one or more events 404. For example, biosensor data A 406A may include information received from biosensors 130 during event A 404A. In an embodiment, task management system 100 may determine from biosensor data 406 whether a user was stressed or relaxed during the respective event. For example, task management system 100 may determine whether a user was stressed or relaxed during event A 404A from biosensor data A 406A. According to an embodiment, task management system 100 may determine whether a user is stressed if the user's heartbeat, blood pressure, facial expressions or other biometric characteristic—or any combination thereof—exceed threshold values.

According to an embodiment, each event 404 may be associated with or related to a respective prediction 408. For example, event A 404A may be related to prediction A 408A, event B 404B may be related to prediction B 408B, event C 404C may be related to prediction C 408C, and event N 404D may be related to prediction N 408D. In an embodiment, predictions 408 may encompass contextual data 104 for the event 404. For example, predictions 408 may include a user's colleague's contextual data for similar events, the priority of the event, the progress of the event, or any combination thereof—to name a few examples. For example, prediction A 408A may include data indicating that a user's colleagues complete event A 404A more effectively and/or more timely when in a state of relaxation.

In an embodiment, each event 404 may be associated with or related to a respective consequence 410. For example, event A 404A may be related to consequence A 410A, event B 404B may be related to consequence B 410B, event C 404C may be related to consequence C 410C, and event N 404D may be related to consequence N 410D. According to an embodiment, consequences 410 may include data indicating task management system's 100 reaction to an event 404 in light of contextual data 104. In an embodiment, task management system 100 may determine a consequence 410 for an event 404 based on a user's colleagues reactions to similar events, the user's reactions to similar events, role 116 standards, dominion standards, or any combination thereof—to name a few examples. For example, consequences 410 may include creating a workflow item 102 after an event 404, the prioritization of an event 404, retrieving a document after an event 404, or any combination thereof—to name a few examples.

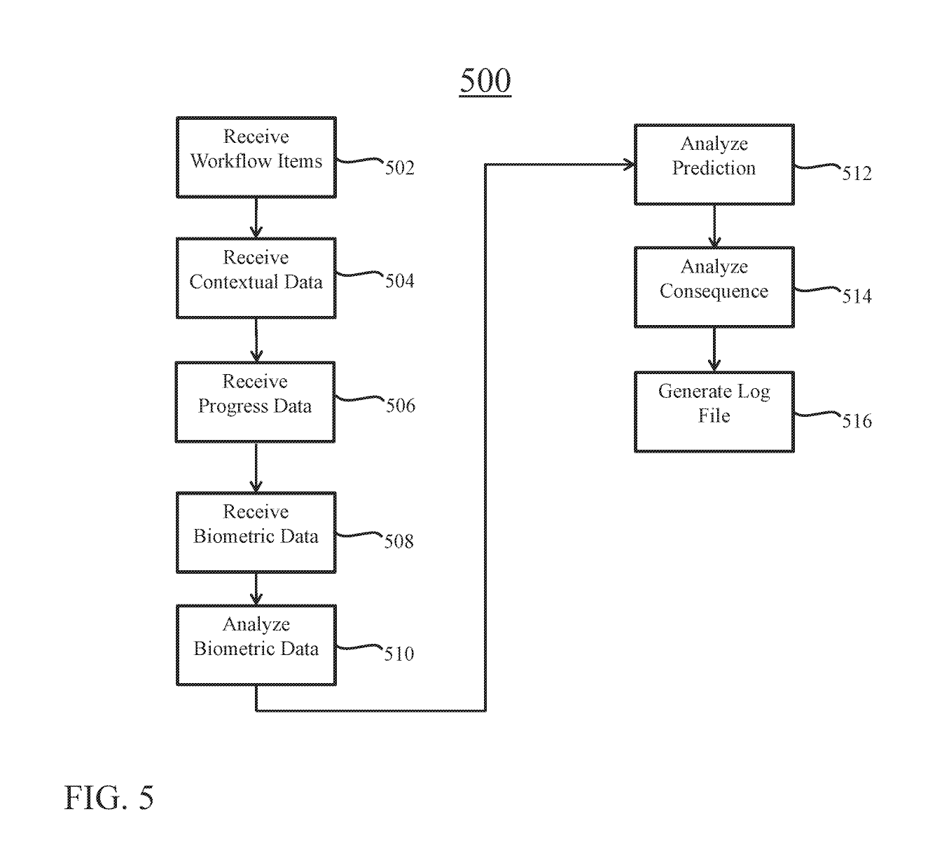

FIG. 5 is a flowchart illustrating a method 500 for creating a log file, according to an embodiment. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to FIGS. 1 and 4. However, method 500 is not limited to those example embodiments.

At 502, task management system 100 may access or receive workflow items 102. As discussed in FIG. 1, workflow items 102 may include tasks, goals, and interruptions. In an embodiment, task management system 100 may list or designate the received workflow items as events 404.

At 504, task management system 100 may access or receive contextual information 104 related to the received workflow items 102. According to an embodiment, the contextual data 104 may include a user's calendar and email chat or instant messaging programs, SMS/MMS systems, the telephone, other messaging facilities, social media platforms, internal enterprise systems, external enterprise systems, information related to a user's domain 114, information related to a user's role 116, a user's environmental conditions, a user's colleagues' contextual information, or any combination thereof. For example, task management system 100 may access or receive a user's calendar for the day, all tasks for the day, calls to be made, or any combination thereof to name a few examples.

At 506, task management system 100 may access or receive information indication a user's progress for events 404. For example, task management system 100 may receive the hourly, percentage, task—or any combination thereof—progress on any given event 404. As a non-limiting example, task management system 100 may receive a user's progress including data indicating that event A 404A is 50% complete.

At 508, task management system 100 may access or receive biosensor information related to events 404, as discussed in FIG. 4. In an embodiment, task management system 100 may list or designate the received biosensor information as biosensor data A 406A, biosensor data B 406B, biosensor data C 406C, etc., respectively for event 404A, event 404B, event 404C, etc.

At 510, task management system 100 may analyze the biosensor data from step 508 to determine a user's state during an event 404. For example, task management system 100 may determine a user's state during event A 404A from the biosensor data A 406A, biosensor data B 406B, biosensor data C 406C, etc. in an embodiment, task management system 100 may compare the received biosensor data to a threshold value. The threshold value may include a value that indicates a heart rate, blood pressure, facial expression, voice volume or any combination thereof at which a person is determined to be in a stressed state. For example, the threshold value may indication a heart rate of 120 beats per minute during an event 404. According to an embodiment, if the received biosensor data is above that threshold value, task management system 100 may determine that a user is stressed during an event. In another embodiment, if the received biosensor data is below the threshold value, task management system 100 may determine that a user is relaxed during an event.

At 512, task management system 100 may analyze the received contextual data to determine predictions for events 404. In an embodiment, task management system 100 may analyze the mean, median, mode, frequency—or any combination thereof—of the received contextual data. According to an embodiment, task management system 100 may use the analyzed contextual data for related events to create a prediction for events 404. For example, task management system 100 may determine a prediction for when event A 404A will be completed based on the mean completion time for a user's past events similar to event A 404A and/or a user's colleagues' events similar to event A 404A. Task management system 100 may list or designate the mean completion time prediction as prediction A 408A for event A 404A.

At 514, task management system 100 may determine consequences 410 for events 404. For example, in an embodiment, task management system 100 may analyze contextual data to determine the most frequent reaction to events similar to events 404, from both users and the system. For example, task management system 100 may determine a user's most frequent past reaction and/or a user's colleagues' most frequent reaction to events similar to event A 404A. Task management system 100 may then list or designate the most frequent reaction as consequence A 410A for event A 404A.

At 516, task management system 100 may generate a log file 402. As described above, the log file 402 may display each event 404 with its associated biosensor data 406, prediction 408, and consequence 410 in the same row, column, line, or any combination thereof. In an embodiment, log file may be stored in a memory, where it may be queried or recalled.

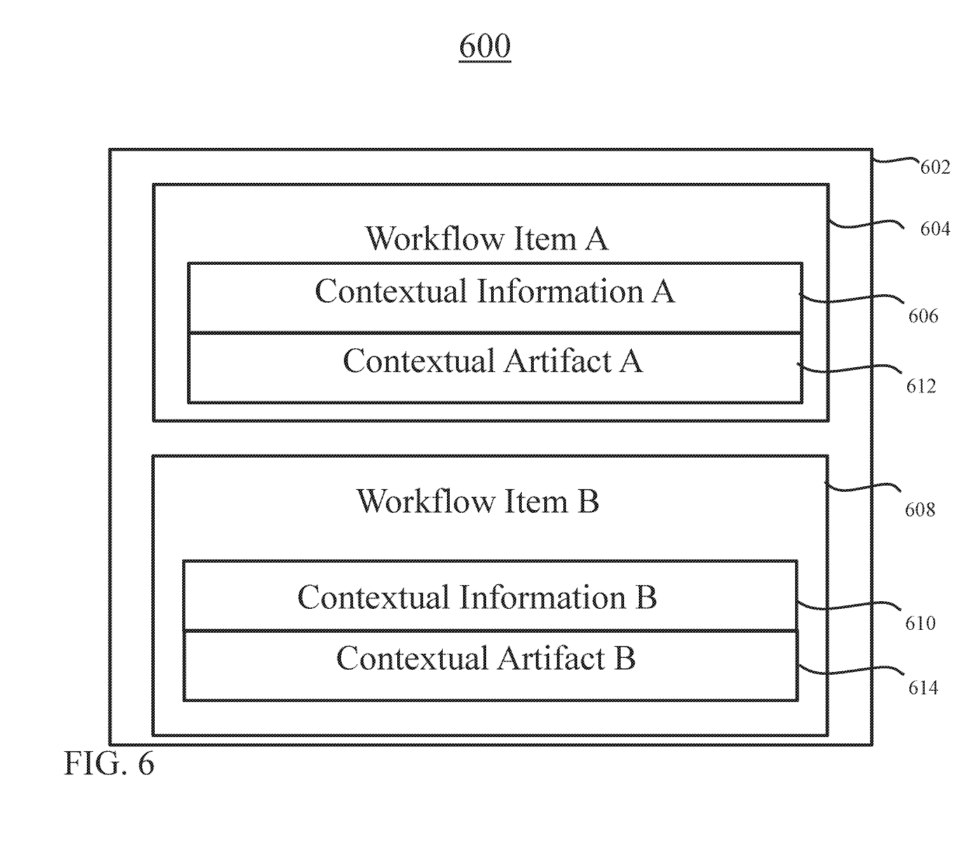

FIG. 6 is diagram illustrating a non-limiting exemplary embodiment of a graphical user interface (GUI) 600 for task management system 100.

According to an embodiment, a user interface (UI) 600 for task management system 100 may comprise priority list 602. Priority list 602 may include workflow item A 604 and workflow item B 608. In an embodiment, priority list 602 may list workflow item A 604 and workflow item B 608 in an order depending on a calculated priority. For example, task management system 100 may determine that workflow item A 604 is to have priority over workflow item B 608 (according to the method 300 of FIG. 3) and may then display workflow item A 604 above workflow item B 608.

In an embodiment, workflow item A 604 may include contextual information A 606 and workflow item B 608 may include contextual information B 610. As discussed in FIG. 1, in some embodiments, contextual information may include information regarding colleagues' similar workflow items, environmental conditions, a user's past similar workflow items, or any combination thereof, to name just a few examples. According to an embodiment, contextual information A 606 may display information related to workflow item A 604 and contextual information B 610 may display information related to workflow item B 608. For example, contextual information A 606 may display the average time it takes a user's colleagues to complete workflow item A 604. Alternatively or additionally, contextual information A 606 may display biosensor data related to workflow item A 604. Similarly, contextual information B 610 may display biosensor data related to workflow item B 608.

According to an embodiment, workflow item A 604 may include contextual artifact A 612 and workflow item B 608 may include contextual artifact B 614. As discussed in FIG. 1, a contextual artifact may display contextual artifacts related to a workflow item, such as files, contacts, programs, or any combination thereof—to name a few examples.

Below is a non-limiting use case of the user interface 600 for task manager system 100, as illustrated in FIG. 6. Assume workflow item A 604 relates to a meeting with the suppliers for car parts, displayed in workflow item A 604, and further that this item is a handover task from a colleague who, for example, is out sick. Contextual information A 606 may display the contextual information (“Let's meet to finalize the costings for the GBI Spark Plugs”) that may have arisen in, for example, an email chain, a telephone conversation, or some other communication and was used to generate the workflow item A 604. Contextual artifact A 612 may display the context-artifacts related to workflow item A 604. For example, content archive A 612 may show two context-artifacts the historical orders for sparkplug GBI, and the latest email from Kate to supplier. Workflow item B 608 may be a goal directed to the user's desire to leave work at 5:15. As can be appreciated, workflow item B 608 may be of lesser importance than workflow item A 604, which is indicated to the user by the placement of workflow item A 604 above workflow item B 608 in the user interface 600.

As another example use case, task management system 100 may display priority list 602 in the user interface 600 after an interruption. In particular, assume the user's workflow has been interrupted by a call from the user's son, and is now placed as workflow item B 608, replacing the goal to leave work at 5:15 and is momentarily moved up to the place of highest importance, i.e., at the top of the priority list 602 (replacing workflow item A 604). The importance of the workflow item B 608 may also be indicated by other visual cues, for example by being colored red. However, the task management system 100 (operating according to method 300 in FIG. 3) may determine the priority of workflow item B 608, the call from the user's son, to actually be of lower priority than workflow item A 604, the meeting with the suppliers. This determination may be based on contextual information 104 relating to past behavior of the user when working on similar events, and/or biosensor data 106 relating to past emotional or physical conditions of the user when working on similar events, for example. Accordingly, task management system 100 may deprioritized workflow item B 608 and placed it below workflow item A 604 in the priority list 602, as shown in FIG. 6.

Assume that after the completion of workflow item A 604, the meeting with the suppliers, the task management system 100 dynamically generates a new workflow item for the priority list 602. The new workflow item may be a task to create a purchase order for the GBI sparkplug order which is placed above workflow item B 608. Given the new workflow item's placement above workflow item B 608, the call from the user's son, the task management system has determined the new workflow item to be of greater importance than workflow item B 608. The new workflow item may be associated with a new contextual information indicating that this task is based on the meeting with the suppliers. The new workflow item may further be associated with a new contextual artifact that may display the standard workflow for this task, comprising the steps of launching the “PO Add” application, requesting purchase order approval, and informing the manager via email. The new contextual artifact may also provide specific contextual information 104 related to the user's particular situation as it relates to the workflow item. For example, the new content archive may offer the guidance of entering “GBI” into the search criteria of the “PO Add” application.

As another example use case, assume the workflow item B 608, the call from the user's son, is placed at a higher priority than the new workflow item, the creation of a purchase order. The task management system 100 may have prioritized in this manner because it determined, for example, that the missed call from the user's son was causing the user added stress based on biosensor data 106. For example, the user may have received an email from his son, which the task management system 100 analyzed and placed with the contextual information B 610. Further, the task management system 100 may perform textual analysis to identify the key words from the email, such as, “Call me back later” and “No worries,” and display them as tags as contextual information. Based on this text analysis which demonstrates a lack of urgency in returning the son's call, the task management system 100 may deprioritize the workflow item B 608 and may place it below the new workflow item related to the creation of a purchase order.

As another example use case, a critical interruption may occur, generating a critical workflow item. The critical workflow item may relate to a production fault emergency that the task management system has tagged as a business risk, as shown in the contextual information associated with the critical workflow item. Additional contextual information associated with the critical workflow item may show that five critical functions are identified. Given the importance of the critical workflow item, task management system 100 may temporarily remove the other workflow items from priority list 602 so as to not distract the user, and enable the user to better focus on the critical workflow item.

Additional use case example embodiments shall now be described.

Tracking Work Like Sports

The task management system 100 can enable users to use biometric data to quantify their sports performance and set goals for themselves in improving their skills. In addition, platforms offer analysis of their performance to enable people to track their effectiveness or improvements over time. In this embodiment, the task management system 100 may use biometric data 106 to track work events workflow items 102), rather than sports events. For example, the task management system 100 can be used to track the stress levels of users during presentations (a work event) and then see how their relative performance improves or decreases over time when performing similar tasks.

Successfulness of Training

Individually or in combination with the embodiment above, task management system 100 can be used to track and measure the performance and effectiveness of a training which is meant to improve a particular work event, e.g. a training to improve presentation skills. Using contextual information 104 such as the aggregated data of the employees who took the training, and their performance gathered in the previous embodiment, the company or organisation could judge the relative success of the training.

Across Company: Employee Evaluation

Using the aggregate of the emotional data tracked of individual employees, task management system 100 can be used to generate an automated ‘spot check’ or employee satisfaction index that considers the employees emotional state while at work. For example, task management system 100 can be used to generate a “happiness index” which could measure how well the employees workplace meets their expectations.

Rating/Report Data Quality: Effectiveness of Response

When a user receives data, either by a report or other means, by capturing emotional data at the point in time that data is viewed by the user, it can be determined whether or not the data was effective for the end user, and what was the reaction of the user. For example, it could be frustration, which could indicate the data wasn't expected. It could be joy which could indicate the user is happy with the data presented. The task management system 100 can be used to perform this function by receiving and analyzing biometric data 308 as described herein.

Product Satisfaction

The task management system 100 can be used to tracking the emotional state of a user biometric data 308) as they use a product as part of performing workflow items 302. By doing this at different stages of the product (for example upon opening, first use, 1 week of use, long term usage etc.) the satisfaction and longevity of the product can be determined.

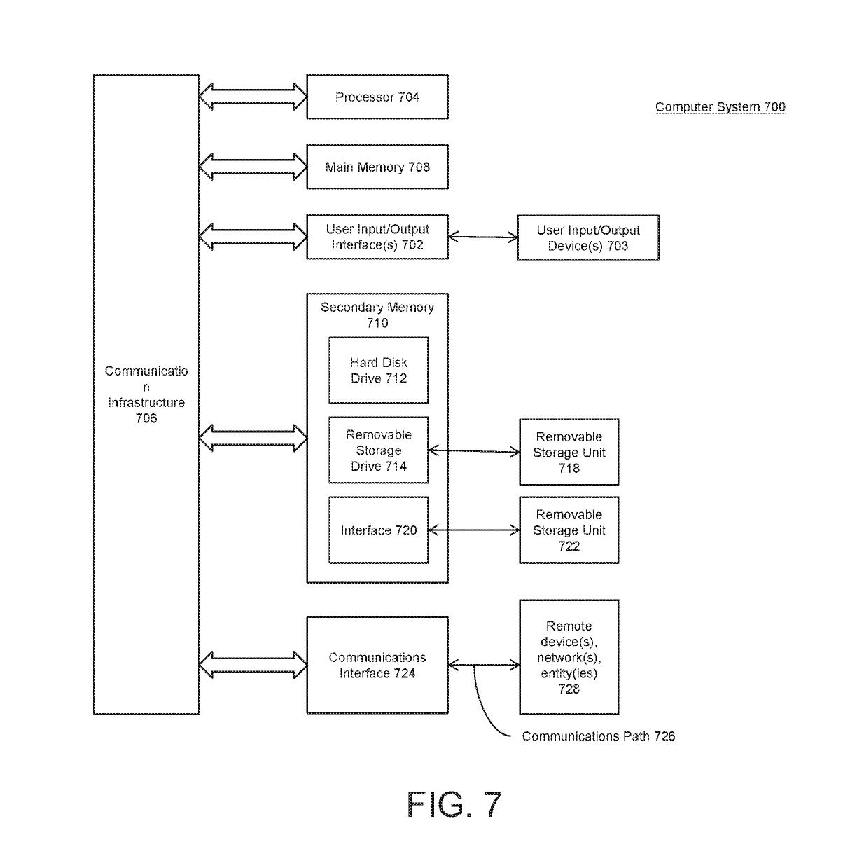

Various embodiments can be implemented, for example, using one or more computer systems, such as computer system 700 shown in FIG. 7. One or more computer systems 700 can be used, for example, to implement the systems, components, flowcharts and operations of FIGS. 1-6. Computer system 700 can be any computer capable of performing the functions described herein.

Computer system 700 can be any well-known computer capable of performing the functions described herein.

Computer system 700 includes one or more processors (also called central processing units, or CPUs), such as a processor 704. Processor 704 is connected to a communication infrastructure or bus 706.

One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 403, such as monitors, keyboards, pointing devices, etc., that communicate with communication infrastructure 406 through user input/output interface(s) 402.

Computer system 700 also includes a main or primary memory 408, such as random access memory (RAM). Main memory 708 may include one or more levels of cache. Main memory 408 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

In an embodiment, a tangible apparatus or article of manufacture comprising a tangible computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein. Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
accessing, by at least one processor, information identifying at least one task and at least one user goal;
accessing, by at least one processor, contextual information related to the at least one task;
determining, by at least one processor, a priority for the at least one task based upon the user goal and contextual information; and
displaying, by at least one processor, the at least one task in a list of task according to the priority.

2. The method of claim 1, wherein the determining further comprises:
determining, by at least one processor, data related to the goal from the contextual information; and
analyzing, by at least one processor, the data related to the goal to determine the priority for the at least one task.

3. The method of claim 1, wherein contextual information is requested from a plurality of sources, wherein access to the plurality of sources is controlled by privacy settings.

4. The method of claim 1, further comprising:
receiving, by at least one processor, biosensor data associated with the at least one task.

5. The method of claim 4, wherein the determining comprises:
comparing, by at least one processor, the received biosensor data to a threshold value;
determining, by at least one processor, a stress level of a user from the comparison of the received biosensor data to the threshold value; and
determining, by at least one processor, the priority based upon the determined stress level.

6. A system, comprising:
a memory; and
at least one processor coupled to the memory and configured to:
access information identifying at least one task and at least one user goal;
access contextual information related to the at least one task;
determine a priority for the at least one task based upon the user goal and contextual information; and
display the at least one task in a list of task according to the priority.

7. The system of claim 6, wherein to determine the at least one processor is further configured to:
determine data related to the goal from the contextual information; and
analyze the data related to the goal to determine the priority for the at least one task.

8. The system of claim 6, wherein contextual information is requested from a plurality of sources, wherein access to the plurality of sources is controlled by privacy settings.

9. The system of claim 6, wherein the at least one processor is further configured to:
receive biosensor data associated with the at least one task.

10. The system of claim 9, wherein to determine the at least one processor is further configured to:
compare the received biosensor data to a threshold value;
determine a stress level of a user from the comparison of the received biosensor data to the threshold value; and
determine the priority based upon the determined stress level.

11. A non-transitory computer-readable device having instructions stored thereon that, when executed by at least one computing device, causes the at least one computing device to perform operations comprising:
accessing information identifying at least one task and at least one user goal;
accessing contextual information related to the at least one task;
determining a priority for the at least one task based upon the user goal and contextual information; and
displaying the at least one task in a list of task according to the priority.

12. The non-transitory computer-readable device of claim 11, wherein the determining further comprises:
determining data related to the goal from the contextual information; and
analyzing the data related to the goal to determine the priority for the at least one task.

13. The non-transitory computer-readable device of claim 11, wherein contextual information is requested from a plurality of sources, wherein access to the plurality of sources is controlled by privacy settings.

14. The non-transitory computer-readable device of claim 11, the operations further comprising:
receiving biosensor data associated with the at least one task.

15. The non-transitory computer-readable device of claim 14, wherein the determining comprises:
comparing the received biosensor data to a threshold value;
determining a stress level of a user from the comparison of the received biosensor data to the threshold value; and
determining the priority based upon the determined stress level.
